(19) United States
(12) Patent Application Publication
(10) Pub. No.: US 2025/0278320 A1
(43) Pub. Date: Sep. 4, 2025

(54) METHOD OF SUPPORTING DATA COLLECTION

(71) Applicant: NETHRU INC., Seoul (KR)

(72) Inventor: Hunsuk RHIM, Seoul (KR)

(21) Appl. No.: 19/212,598

(22) Filed: May 19, 2025

Related U.S. Application Data
(63) Continuation of application No. PCT/KR2024/008091, filed on Jun. 12, 2024.

(30) Foreign Application Priority Data
Nov. 1, 2023 (KR) 10-2023-0149372

(51) Int. Cl. G06F 9/54; G06F 9/451

(52) U.S. Cl. CPC G06F 9/544; G06F 9/451; G06F 2209/545

(57) ABSTRACT

A method of supporting data collection for a user terminal including at least one processor according to some embodiments of the present disclosure is disclosed. The method of supporting data collection for the user terminal may comprise: accessing a pre-designated library in response to execution of a target application; transmitting a report signal for readiness to receive instructions to an address defined in the library; receiving an instruction signal defined in a first programming language; determining a response signal for the instruction signal according to presence or absence of an API (application programming interface) corresponding to the instruction signal; and transmitting the response signal to the address defined in the library.

### CROSS-REFERENCE TO RELATED APPLICATION

This application is a US Bypass Continuation Application of International Application No. PCT/KR2024/008091, filed on Jun. 12, 2024, which claims priority to and the benefit of Korean Patent Application No. 10-2023-0149372, filed on Nov. 1, 2023, the disclosure of which is incorporated herein by reference in its entirety.

### BACKGROUND

### Technical Field

The present disclosure relates to a method of supporting data collection, and more specifically, to a method of supporting data collection for a user terminal.

### Background Art

The process of distributing apps for the Android operating system can be summarized as follows.

Application Development: First, the app to be executed on the user terminal must be developed. This process may include user interface design, app logic implementation, and testing.

Application Build: Once app development is complete, the app must be built. Building may refer to the process of compiling source code and packaging it into an APK (Android Package) file.

Signing: The app must be signed. For APK files, adding a signature allows the app to be recognized as coming from a trusted source. Signing may use a debug keystore for development or a release keystore for production.

Google Play Console Registration: To distribute the app on the Google Play Store, it must be registered on the Google Play Console. Through this, app information, pricing, descriptions, screenshots, and version management can be configured.

APK Upload: The APK file is uploaded on the Google Play Console. A release APK file can be uploaded, or various release tracks such as Alpha, Beta, and Production can be set.

Resource and Store Page Configuration: Resources such as app icons, graphic materials, descriptions, and app store pages are configured.

Pricing and Country Settings: The app's price is set, and the countries where it will be available are specified. Free or paid apps can be selected, and pricing policies can be managed.

Release and Review: The app is released on the Google Play Console and undergoes Google's review process. The review process involves checking the app's content and compliance with advertising policies.

Application Distribution: Once the review is complete, the app is distributed on the Google Play Store. Users can search for and download the app from the store.

Application Update Management: When updating the app or releasing a new version, the previous steps are repeated to upload a new APK file and release it.

User Support and Feedback Management: Interaction with users who use the app is managed, and feedback and issue reports are handled to contribute to app improvement.

Marketing and Promotion: After successfully distributing the app, marketing and promotional activities are conducted to attract more users and promote the app.

Natively developed Android applications generally need to follow the above distribution process to reflect the application content. The processes of development, build, testing, and distribution consume significant time and resources, and even when using methods to update the application, the processes of development, build, and testing are still required. Additionally, methods for patching resources remotely cannot change the execution entity, so the changes are limited.

### SUMMARY

### Technical Problem

The present disclosure has been devised in response to the aforementioned background art and aims to provide a method of supporting data collection for a user terminal, which allows changing items to be collected without rebuilding or redistributing an application.

The technical problems of the present disclosure are not limited to the technical problems mentioned above, and other technical problems not mentioned will be clearly understood by those skilled in the art from the following description.

### Technical Solution

According to one embodiment of the present disclosure for solving the above-described problems, a method of supporting data collection for a user terminal including at least one processor is disclosed. The method of supporting data collection for the user terminal may comprise: accessing a pre-designated library in response to execution of a target application; transmitting a report signal for readiness to receive instructions to an address defined in the library; receiving an instruction signal defined in a first programming language; determining a response signal for the instruction signal according to presence or absence of an API (application programming interface) corresponding to the instruction signal; and transmitting the response signal to the address defined in the library.

In addition, the API corresponding to the instruction signal may be defined in a second programming language corresponding to an operating system of the user terminal.

In addition, determining the response signal may comprise: transmitting an output value defined in the API as the response signal to the address defined in the library when the API corresponding to the instruction signal exists in the library; or transmitting an error signal for the instruction signal as the response signal to the address defined in the library when the API corresponding to the instruction signal does not exist in the library.

In addition, determining the response signal for the instruction signal according to presence or absence of the API (application programming interface) corresponding to the instruction signal may comprise: parsing the instruction signal to generate an instruction; and executing the generated instruction to determine whether the API corresponding to the instruction signal exists in the library.

In addition, the instruction signal may comprise at least one tag object designating a tag to be collected, and each of the at least one tag object may comprise a trigger object in which a condition for executing the tag object is set and a variable object designating data to be collected.

In addition, the instruction signal may be generated such that each of the at least one tag object is selectively collected based on a user interaction input corresponding to a pre-designated graphic object, and the pre-designated graphic object may comprise a first graphic object indicating a collection command corresponding to a first tag object, a first-1 graphic object indicating an execution command for a trigger condition associated with the first tag object, and a first-2 graphic object indicating a collection command for a variable associated with the first tag object.

In addition, determining the response signal for the instruction signal according to presence or absence of the API (application programming interface) corresponding to the instruction signal may comprise: determining whether a first tag object determined to collect a tag based on the instruction signal exists among the at least one tag object; determining whether to collect a first trigger object included in the first tag object based on the instruction signal when the first tag object exists; and determining whether to collect each first variable object included in the first tag object based on the instruction signal when the first tag object exists.

In addition, the at least one tag object may comprise at least one of a basic tag object using a pre-defined tag object and a user-created tag object.

In addition, a method of supporting data collection for a server including at least one processor may comprise: receiving a report signal for readiness to receive instructions from a user terminal; transmitting an instruction signal defined in a first programming language in response to the report signal; and receiving a response signal for the instruction signal from the user terminal.

In addition, receiving the response signal for the instruction signal from the user terminal may comprise: receiving an output value defined in the API as the response signal when the API corresponding to the instruction signal exists in a library of the user terminal; or receiving an error signal in response to the instruction signal when the API corresponding to the instruction signal does not exist in the library.

In addition, the API corresponding to the instruction signal may be defined in a second programming language corresponding to an operating system of the user terminal.

In addition, the instruction signal may be generated as an instruction for confirming whether the API corresponding to the instruction signal defined in the first programming language exists in the library when parsed by the user terminal.

In addition, the instruction signal may comprise at least one tag object designating a tag to be collected, and each of the at least one tag object may comprise a trigger object in which a condition for executing the tag object is set and a variable object designating data to be collected.

In addition, the instruction signal may be generated such that each of the at least one tag object is selectively collected based on a user interaction input corresponding to a pre-designated graphic object, and the pre-designated graphic object may comprise a first graphic object indicating a collection command corresponding to a first tag object, a first-1 graphic object indicating an execution command for a trigger condition associated with the first tag object, and a first-2 graphic object indicating a collection command for a variable associated with the first tag object.

In addition, transmitting the instruction signal defined in the first programming language in response to the report signal may comprise: determining whether a first tag object determined to collect a tag based on the user interaction input exists among the at least one tag object; determining whether to collect a first trigger object included in the first tag object based on the user interaction input when the first tag object exists; and determining whether to collect each first variable object included in the first tag object based on the user interaction input when the first tag object exists.

In addition, the at least one tag object may comprise at least one of a basic tag object using a pre-defined tag object and a user-created tag object.

The technical solutions that can be obtained from the present disclosure are not limited to the solutions mentioned above, and other solutions not mentioned may be clearly understood by those skilled in the art to which the present disclosure pertains from the following description.

### Effect of Invention

The present disclosure can provide a method capable of conveniently changing items to collect data without rebuilding or redistributing the application, according to some embodiments of the present disclosure.

The effects obtainable from the present disclosure are not limited to the effects mentioned above, and other effects not mentioned may be clearly understood by those skilled in the art to which the present disclosure pertains from the description below.

### BRIEF DESCRIPTION OF THE DRAWINGS

Various aspects are now described with reference to the drawings, where like reference numerals are used to collectively refer to like components. In the following embodiments, for the purpose of explanation, numerous specific details are presented to provide a comprehensive understanding of one or more aspects. However, it will be apparent that such aspect(s) can be implemented without these specific details. In other instances, well-known structures and devices are shown in block diagram form to facilitate the description of one or more aspects.

FIG. 1 illustrates an exemplary system for performing a method of supporting data collection according to some embodiments of the present disclosure.

FIG. 2 is a flowchart illustrating an example of a method of supporting data collection performed by a user terminal according to some embodiments of the present disclosure.

FIG. 3 is a flowchart illustrating an example of a method in which a user terminal transmits a response signal according to some embodiments of the present disclosure.

FIG. 4 is a flowchart illustrating an example of a method of supporting data collection performed by a server according to some embodiments of the present disclosure.

FIG. 5 is a diagram illustrating an example of a method of supporting data collection performed by a server and a user terminal according to some embodiments of the present disclosure.

FIG. 6 is a diagram illustrating an example of at least one tag object according to some embodiments of the present disclosure.

### DETAILED DESCRIPTION

The present invention may undergo various modifications and have various embodiments, and specific embodiments are illustrated in the drawings and described in detail in the detailed description. However, this is not intended to limit the invention to specific embodiments, and it should be understood to include all modifications, equivalents, and substitutes included within the spirit and scope of the invention. Similar reference numerals are used for similar components while describing each drawing.

The terms first, second, A, B, etc., may be used to describe various components, but the components should not be limited by these terms. These terms are used only for the purpose of distinguishing one component from another. For example, without departing from the scope of the present invention, a first component may be referred to as a second component, and similarly, the second component may also be referred to as the first component. The term and/or includes a combination of a plurality of related listed items or any of the plurality of related listed items.

When a component is referred to as being “connected to” or “coupled to” another component, it should be understood that it may be directly connected or coupled to the other component, or intervening components may be present. In contrast, when a component is referred to as being “directly connected to” or “directly coupled to” another component, it should be understood that no intervening components are present.

The terms used in this application are merely for the purpose of describing specific embodiments and are not intended to limit the invention. Singular expressions include plural expressions unless the context clearly indicates otherwise. In this application, terms such as “comprising” or “having” are intended to specify the presence of features, numbers, steps, operations, components, parts, or combinations thereof described in the specification, and should not be understood to preclude the possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which this invention belongs. Terms defined in commonly used dictionaries should be interpreted as having meanings consistent with the context of the relevant technology and should not be interpreted in an idealized or overly formal sense unless explicitly defined in this application.

In this disclosure, a user terminal may receive an instruction signal from a server. Here, the instruction signal may be a script or the like. The script may be a programming language that can be executed without compiling the source code. The user terminal may transmit a response signal corresponding to the received instruction signal to the server. Accordingly, the user of the server can collect data from the user terminal without rebuilding or redistributing the application.

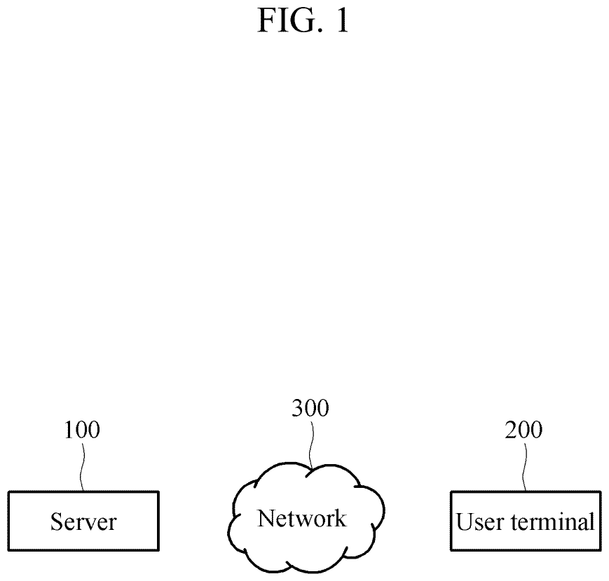

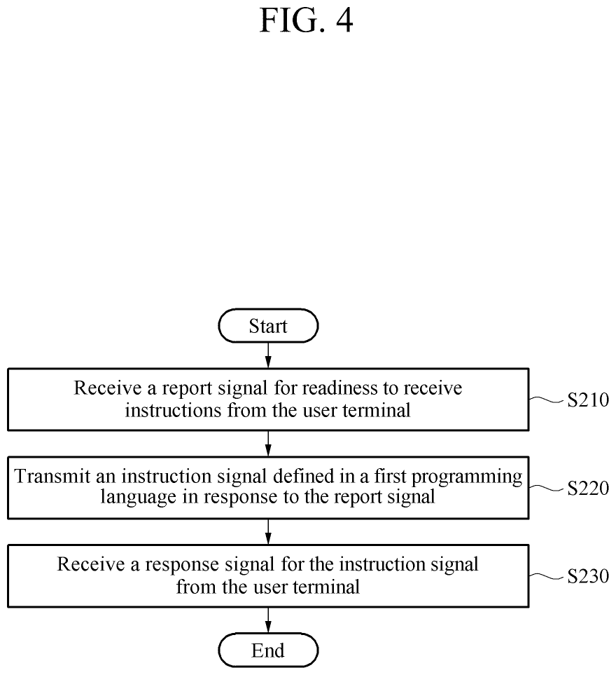

Hereinafter, a method of supporting data collection performed by the user terminal will be described with reference to FIGS. 1 to 3, and a method of supporting data collection performed by the server will be described with reference to FIG. 4.

FIG. 1 illustrates an exemplary system for performing a method of supporting data collection according to some embodiments of the present disclosure.

Referring to FIG. 1, the system for performing the method of supporting data collection may comprise a server 100, a user terminal 200, and a network 300.

The server 100 may include any type of computer system or computer device, such as a microprocessor, mainframe computer, digital processor, portable device, or device controller.

The server 100 may achieve desired system performance using a combination of typical computer hardware (e.g., devices that may include computer processors, memory, storage, input devices, and output devices, and other components of conventional computing devices; electronic communication devices such as routers and switches; electronic information storage systems such as network-attached storage (NAS) and storage area networks (SAN)) and computer software (i.e., instructions that enable computing devices to function in a specific manner).

The server 100 may comprise a control unit, a storage unit, and a communication unit, among others. However, the above-described components are not essential for implementing the server 100, and the server 100 may have more or fewer components than those listed above.

The control unit may generally handle the overall operation of the server 100. By processing signals, data, and information input or output through the components of the server 100 or by driving applications stored in the storage unit, the control unit may provide or process appropriate information or functions for the user.

The control unit may comprise one or more cores and may include processors for data analysis, such as a Central Processing Unit (CPU), a General Purpose Graphics Processing Unit (GPGPU), or a Tensor Processing Unit (TPU).

The storage unit may include memory and/or a permanent storage medium. The memory may include at least one type of storage medium, such as flash memory type, hard disk type, multimedia card micro type, card-type memory (e.g., SD or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, or optical disk.

The communication unit may include one or more modules that enable communication between the server 100 and a communication system, between the server 100 and the user terminal 200, or between the server 100 and the network 300.

In this disclosure, the server 100 may transmit an instruction signal to the user terminal 200. The instruction signal may be defined in a first programming language. The first programming language may be a script language. The script language may be a programming language that can be executed without compiling the source code. When the instruction signal is received, the user terminal 200 may transmit a response signal to the server 100 using an API (application programming interface) corresponding to the instruction signal. Accordingly, the server 100 may collect data from the user terminal 200. Hereinafter, a method of supporting data collection performed by the server 100 will be described with reference to FIG. 4.

The user terminal 200 may achieve desired system performance using a combination of typical computer hardware (e.g., devices that may include computer processors, memory, storage, input devices, and output devices, and other components of conventional computing devices; electronic communication devices such as routers and switches; electronic information storage systems such as Network-Attached Storage (NAS) and Storage Area Networks (SAN)) and computer software (i.e., instructions that enable computing devices to function in a specific manner). The user terminal 200 may include any type of terminal capable of connecting to a wired or wireless network, such as a PC (Personal Computer), notebook, mobile terminal, smartphone, tablet PC, or the like, owned by the user.

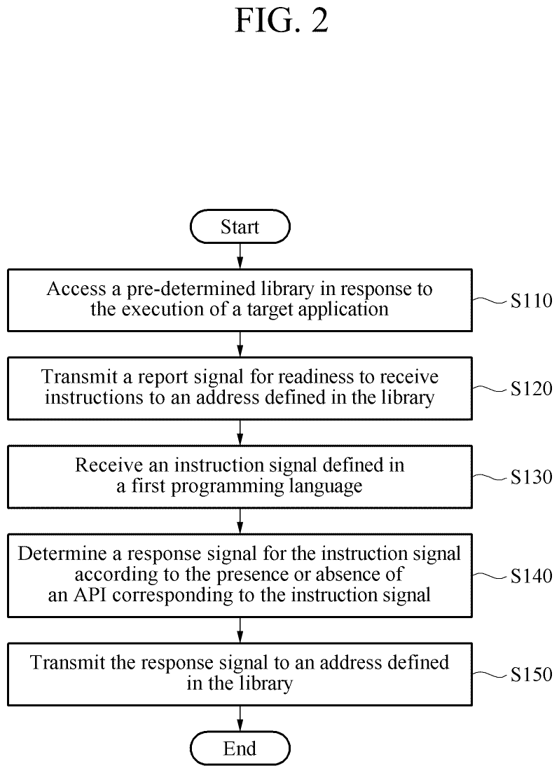

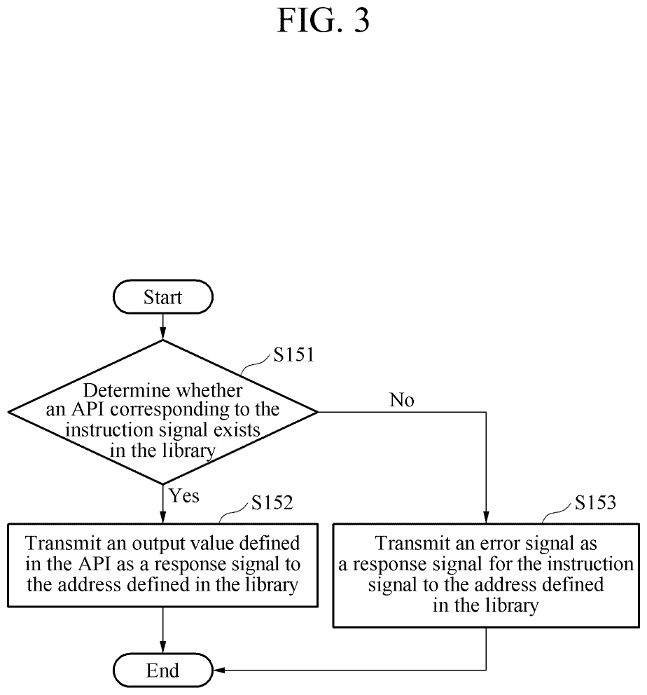

In the present disclosure, the user terminal 200 may transmit a response signal for an instruction signal received from the server 100. The response signal may include data collected by the user terminal 200. Hereinafter, an example of a method in which the user terminal 200 transmits a response signal for an instruction signal received from the server 100 will be described with reference to FIGS. 2 and 3.

The network 300 may be a closed network such as a LAN (Local Area Network) or WAN (Wide Area Network), or an open network such as the Internet. The Internet refers to a global open computer network structure that provides various services existing in the TCP/IP protocol and its upper layers, such as HTTP (Hyper Text Transfer Protocol), Telnet, FTP (File Transfer Protocol), DNS (Domain Name System), SMTP (Simple Mail Transfer Protocol), SNMP (Simple Network Management Protocol), NFS (Network File Service), and NIS (Network Information Service).

Hereinafter, an example of a method of supporting data collection performed by the user terminal 200 will be described.

FIG. 2 is a flowchart illustrating an example of a method of supporting data collection performed by a user terminal according to some embodiments of the present disclosure.

Referring to FIG. 2, the user terminal 200 may access a pre-determined library in response to the execution of a target application (S110).

The target application may be an application pre-distributed for data collection. The target application may be an application in which an SDK (Software Development Kit) is installed in the form of a library. When the target application is executed based on input from a user, the user terminal 200 may access the pre-determined library.

The user terminal 200 may transmit a report signal for readiness to receive instructions to an address defined in the library (S120). Here, the address defined in the library may be an address at which the server 100 can receive the report signal.

The user terminal 200 may receive an instruction signal defined in a first programming language from the server 100 (S130). The first programming language may be a scripting language.

For example, the instruction signal may include scripts related to deviceBrand, displaySize, and view (“Button”).text.

According to one embodiment, the instruction signal defined in the first programming language may comprise at least one object.

Specifically, the instruction signal may comprise at least one tag object, trigger object, and variable object. The trigger object and variable object may be subcomponents of at least one tag object. In other words, at least one tag object may comprise trigger objects and variable objects.

The tag object may designate an item to be collected.

For example, the tag object may designate an object to be collected, such as a button click, a specific key click, a specific object click, a touch, or a touch of a specific object.

The trigger object may set a condition under which the tag object is executed.

For example, the trigger object may be an object that collects data when an action such as a button click, a specific key click, a specific object click, a touch, or a touch of a specific object occurs.

In another example, the trigger object may be an object that collects data when specific data is changed.

The variable object may be an object that designates data to be collected. The variable object may be set to collect specific data of a specific class.

According to some embodiments of the present disclosure, the instruction signal may be generated such that each of at least one tag object is selectively collected based on a user interaction input corresponding to a pre-designated graphic object. Here, the user interaction may be an interaction performed between the server 100 and the user of the server 100.

Specifically, each of at least one tag object may correspond to at least one graphic object. Assuming that a first tag object exists among at least one tag object, a first graphic object corresponding to the first tag object may exist. The instruction signal may be generated to selectively collect the first tag object in response to user interaction with the first graphic object.

For example, the instruction signal may be generated to collect the first tag object in response to user interaction with the first graphic object. In another example, the instruction signal may be generated not to collect the first tag object in response to user interaction with the first graphic object.

The pre-designated graphic object may comprise a first graphic object indicating a collection command corresponding to a first tag object, a first-1 graphic object indicating an execution command for a trigger condition associated with the first tag object, and a first-2 graphic object indicating a collection command for a variable associated with the first tag object. The first-1 graphic object and the first-2 graphic object may be sub-objects of the first graphic object.

Specifically, the instruction signal may be generated to collect the first tag object in response to user input for the first graphic object. When the instruction signal is generated to collect the first tag object, the instruction signal may be generated to selectively collect the first trigger object in response to user interaction with the first-1 graphic object.

For example, the instruction signal may be generated to collect the first trigger object in response to user interaction with the first-1 graphic object. In another example, the instruction signal may be generated not to collect the first trigger object in response to user interaction with the first-1 graphic object.

Additionally, when the instruction signal is generated to collect the first tag object, the instruction signal may be generated to selectively collect the first variable object in response to user interaction with the first-2 graphic object.

For example, the instruction signal may be generated to collect the first variable object in response to user interaction with the first-2 graphic object. In another example, the instruction signal may be generated not to collect the first variable object in response to user interaction with the first-2 graphic object.

The user terminal 200 may determine a response signal for the instruction signal according to the presence or absence of an API (application programming interface) corresponding to the instruction signal (S140).

Specifically, the user terminal 200 may determine whether a first tag object determined to collect a tag based on the instruction signal exists among at least one tag object. When the first tag object exists, the user terminal 200 may determine whether to collect the first trigger object included in the first tag object based on the instruction signal. Additionally, when the first tag object exists, the user terminal 200 may determine whether to collect the first variable object included in the first tag object based on the instruction signal.

For example, when the first tag object exists based on the instruction signal, the user terminal 200 may collect objects related to the first tag object. The user terminal 200 may collect objects such as a button click, a specific key click, a specific object click, a touch, or a touch of a specific object related to the first tag object. In another example, when the first tag object determined to collect a tag based on the instruction signal does not exist among at least one tag object, the user terminal 200 may not collect objects related to the first tag object.

The user terminal 200, when it is determined to collect the first trigger object, may collect data according to the occurrence of actions such as button clicks, specific key clicks, specific item clicks, touches, or touches of specific objects related to the first trigger object.

The user terminal 200, when it is determined to collect the first variable object, may collect specific data of a specific class related to the first variable object.

The user terminal 200 may parse the instruction signal to generate an instruction. Parsing may be an operation of generating an instruction by decomposing the components of a sentence and determining the hierarchical relationship of the decomposed components. The user terminal 200 may interpret the script content of the instruction signal and convert it into an instruction for execution. The user terminal 200 may execute the generated instruction to determine whether an API corresponding to the instruction signal exists in the library. Here, the API may be an interface defined in a second programming language corresponding to the operating system of the user terminal 200.

For example, the user terminal 200 may be an Android-based terminal. In this case, the API may be an interface defined in a programming language corresponding to the Android operating system.

In another example, the user terminal 200 may be an iOS-based terminal. In this case, the API may be an interface defined in a programming language corresponding to the iOS operating system.

According to some embodiments of the present disclosure, the user terminal 200 may determine a response signal based on whether an API corresponding to the instruction signal exists in the library.

For example, the user terminal 200 may transmit an output value defined in the API as a response signal when the API corresponding to the instruction signal exists in the library.

In another example, the user terminal 200 may transmit an error signal as a response signal for the instruction signal when the API corresponding to the instruction signal does not exist in the library. Hereinafter, an example of a method by which the user terminal 200 transmits a response signal will be described with reference to FIG. 3.

The user terminal 200 may transmit the response signal to an address defined in the library (S150). Here, the address defined in the library may be an address at which the server 100 can receive the response signal. The address defined in the library may be an address at which the server 100 can receive data collected by the user terminal 200. Alternatively, the address defined in the library may be an external server for data collection designated by a user of the server 100.

For example, the instruction signal may include a script related to deviceBrand, displaySize, and view (“Button”).text.

The API corresponding to the script related to deviceBrand may be an API for checking the brand of the user terminal 200. The user terminal 200 may return brands such as “google,” “samsung,” or “apple” through the API.

The API corresponding to the script related to displaySize may be an API for checking the screen resolution of the user terminal 200. The user terminal 200 may return values such as “1440” or “3036” through the API.

The API corresponding to the script related to view (“Button”) may be view (argument). The API may search for a UI corresponding to the given argument and return an instance of the UI (a value that uniquely identifies the UI in the application).

The API corresponding to the script related to .text may be instance.text. The API may check and return the text displayed to the user in the corresponding UI instance.

The user terminal 200 may transmit the values returned through the APIs as a response signal to the address defined in the library. According to one embodiment, the user terminal 200 may convert the returned values into human-readable text and transmit them to the server 100.

According to the above configuration, the user terminal 200 may receive an instruction signal from the server 100. The user terminal may transmit data related to the instruction signal as a response signal to the server 100 or the address defined in the library. The instruction signal may be a signal that does not require rebuilding or redistributing the application. Accordingly, the user associated with the server 100 may conveniently select and extract data to be collected from the user terminal 200 in real time.

Meanwhile, according to some embodiments of the present disclosure, the user terminal 200 may determine a response signal based on whether an API corresponding to the instruction signal exists in the library. Hereinafter, an example of a method by which the user terminal 200 transmits a response signal according to the present disclosure will be described with reference to FIG. 3.

FIG. 3 is a flowchart illustrating an example of a method by which a user terminal transmits a response signal according to some embodiments of the present disclosure.

Referring to FIG. 3, the user terminal 200 may determine whether an API corresponding to the instruction signal exists in the library.

When the API corresponding to the instruction signal exists in the library (S151, Yes), the user terminal 200 may transmit an output value defined in the API as a response signal to the address defined in the library (S152).

For example, the instruction signal may include a script related to deviceBrand, displaySize, and view (“Button”).text.

The API corresponding to the script related to deviceBrand may be an API for checking the brand of the user terminal 200. When the API corresponding to the script related to deviceBrand exists, the user terminal 200 may return brands such as “google,” “samsung,” or “apple” as an output value. Then, the user terminal 200 may transmit the returned output value as a response signal to the address defined in the library.

When the API corresponding to the instruction signal does not exist in the library (S151, No), the user terminal 200 may transmit an error signal as a response signal for the instruction signal to the address defined in the library (S153).

For example, the API corresponding to the script related to displaySize may be an API for checking the screen resolution of the user terminal 200. When the API corresponding to the script related to displaySize does not exist, the user terminal 200 may transmit an error signal as a response signal to the address defined in the library.

According to the above configuration, the user terminal 200 may receive an instruction signal from the server 100. The instruction signal may include only a script for adding or changing items to collect data. Therefore, the instruction signal may only read data from the variables of the code of the application installed on the user terminal 200 without generating or changing the data. Accordingly, even if the user terminal 200 receives an instruction signal from the server 100, no problem may occur in the installed application.

Hereinafter, an example of a method by which the server 100 receives a response signal from the user terminal 200 will be described.

FIG. 4 is a flowchart illustrating an example of a method of supporting data collection performed by a server according to some embodiments of the present disclosure.

Referring to FIG. 4, the server 100 may receive a report signal for readiness to receive instructions from the user terminal 200 (S210).

Specifically, the user terminal 200 may access a pre-designated library in response to the execution of a target application. When the pre-designated library is accessed, the user terminal 200 may transmit a report signal for readiness to receive instructions to an address defined in the library. Accordingly, the server 100 may receive the report signal.

The server 100 may transmit an instruction signal defined in a first programming language in response to the report signal (S220). When the instruction signal is parsed by the user terminal 200, it may be generated as an instruction for confirming whether an API corresponding to the instruction signal defined in the first programming language exists in the library.

For example, the server 100 may transmit an instruction signal written in or including a script language to the user terminal 200.

According to one embodiment, the server 100 may determine whether a first tag object determined to collect a tag among at least one tag object based on a user interaction input exists. If the first tag object exists, the server 100 may determine whether to collect a first trigger object included in the first tag object based on the user interaction input.

Additionally, if the first tag object exists, the server 100 may determine whether to collect a first variable object included in the first tag object based on the user interaction input. The server 100 may generate an instruction signal based on the determination result.

For example, the server 100 may generate an instruction signal to collect the first tag object, the first trigger object, and the first variable object. In another example, the server 100 may generate an instruction signal to collect the first tag object. In yet another example, the server 100 may generate an instruction signal to collect the first tag object and the first trigger object. In yet another example, the server 100 may generate an instruction signal to collect the first tag object and the first variable object. In yet another example, the server 100 may generate an instruction signal not to collect the first tag object. In this case, the instruction signal may also be generated such that the first trigger object and the first variable object are not collected.

The server 100 may receive a response signal for the instruction signal from the user terminal 200 (S230).

For example, if an API corresponding to the instruction signal exists in the library of the user terminal 200, the server 100 may receive an output value returned by the user terminal 200 in response to the instruction signal as the response signal. In another example, if an API corresponding to the instruction signal does not exist in the library of the user terminal 200, the server 100 may receive an error signal for the instruction signal as the response signal.

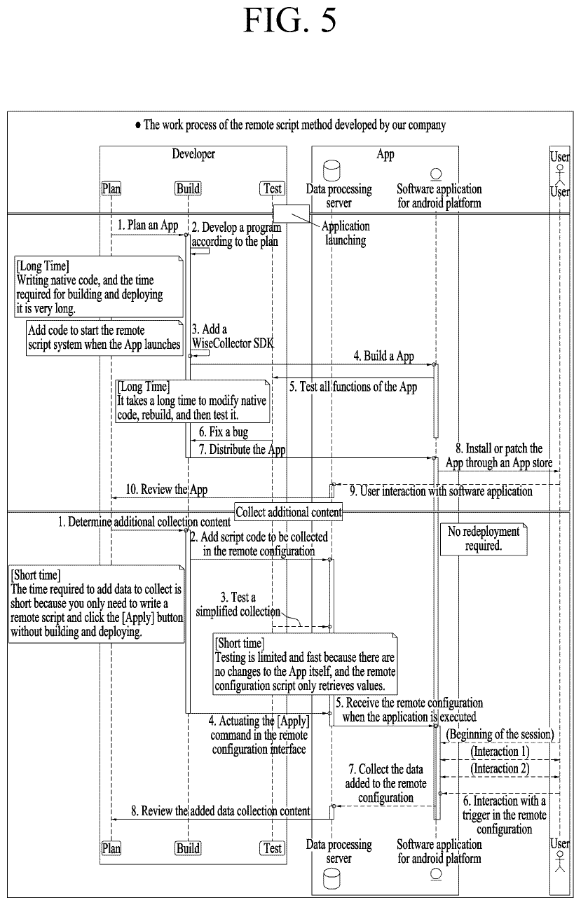

FIG. 5 is a diagram illustrating an example of a method of supporting data collection performed in a server and a user terminal according to some embodiments of the present disclosure.

Referring to FIG. 5, a developer may plan an app. The app may be an abbreviation for an application. The developer may develop a program according to the plan. The developer may add a code to start a remote script system at the start of the app as an SDK within the program. The developer may build the app. When the app is built, all functions of the app may be tested. If bugs exist based on the test results, the developer may fix the bugs. Then, the developer may distribute the app.

As the app is distributed, the user terminal 200 may install or patch the app through an app store provided by the operating system. The user terminal 200 may use the app based on input from the user. The developer may review the app by receiving data according to the use of the app.

The developer may determine additional collection content. Conventionally, when deciding to add content to be collected from the user terminal 200, it was necessary to return to the program development (or program modification) stage and rebuild the program. Then, the app build, test, bug fix, and distribution processes had to be repeated. On the other hand, according to the method of supporting data collection of the present disclosure, the developer may conveniently add content to be collected by adding script code to be collected in a remote configuration.

Specifically, when the additional collection content is determined, the developer may add script code to be collected in the remote configuration. The developer may test a simplified collection. Since there are no changes to the application itself and only the value of the remote configuration script is obtained, the simplified collection test may be performed quickly. The developer may apply the script code in the remote configuration.

The user terminal 200 may receive the remote configuration when the application is executed. Here, receiving the remote configuration may mean that the additional collection content is applied as script code. Accordingly, the user terminal 200 may collect the data added to the remote configuration. Then, the user terminal 200 may transmit the collected data to the developer. The developer may review the added data collection content.

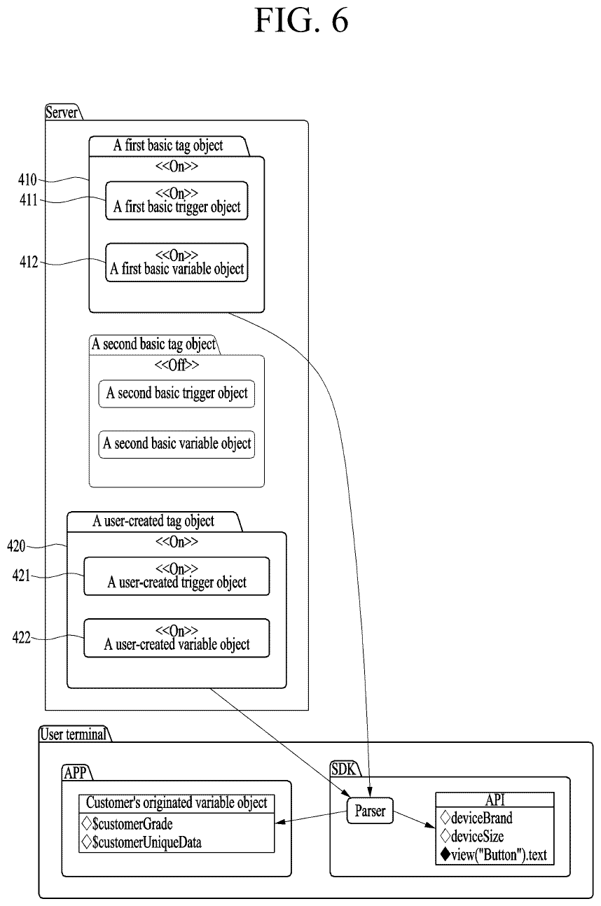

FIG. 6 is a diagram illustrating an example of at least one tag object according to some embodiments of the present disclosure. FIG. 6 may be a diagram illustrating an example of at least one tag object, not a user interface provided by the server 100.

Referring to FIG. 6, the at least one tag object may comprise a first basic tag object 410 and a second user-created tag object 420.

The first basic tag object 410 may comprise a first basic trigger object 411 and a first basic variable object 412. The first basic tag object 410 may be selectively collected based on a user interaction input. If it is determined that the first basic tag object 410 is to be collected, the first basic trigger object 411 and the first basic variable object 412 may be selectively collected based on the user interaction input.

The second user-created tag object 420 may comprise a second user-created trigger object 421 and a second user-created variable object 422. The second user-created tag object 420 may be selectively collected based on a user interaction input. If it is determined that the second user-created tag object 420 is to be collected, the second user-created trigger object 421 and the second user-created variable object 422 may be selectively collected based on the user interaction input.

According to some embodiments of the present disclosure, the first basic tag object 410 may be a basic tag object using a pre-defined tag object. The second user-created tag object 420 may be a user-created tag object. In other words, the at least one tag object may comprise at least one of a basic tag object and a user-created tag object.

The basic tag object may be an object in which a pre-written remote script by a developer of the server 100 or the like is embedded. The user-created tag object may be an object in which a remote script is written by a user who purchased a program for executing the aforementioned method of supporting data collection.

Applications of a similar type may often have similar data collection content desired by the company developing the application. Therefore, the server 100 may provide basic tag objects based on the general requirements of each developer. However, while the requirements may be similar, the requirements for all developments may not be identical. Therefore, the user may create a user-created tag object suitable for themselves.

The description of the presented embodiments is provided to enable any person skilled in the art to make or use the present disclosure. Various modifications to these embodiments will be apparent to those skilled in the art, and the general principles defined herein may be applied to other embodiments without departing from the scope of the present disclosure. Thus, the present disclosure is not intended to be limited to the embodiments presented herein but is to be accorded the broadest scope consistent with the principles and novel features disclosed herein.

What is claimed is:

1. A method of supporting data collection for a user terminal including at least one processor, comprising:
accessing a pre-determined library in response to execution of a target application;
transmitting a report signal for readiness to receive instructions to an address defined in the library;
receiving an instruction signal defined in a first programming language;
determining a response signal for the instruction signal according to presence or absence of an application programming interface (API) corresponding to the instruction signal; and
transmitting the response signal to the address defined in the library.

2. The method of supporting data collection of claim 1, wherein
the API corresponding to the instruction signal is defined in a second programming language corresponding to an operating system of the user terminal.

3. The method of supporting data collection of claim 1, wherein
the determining the response signal comprises:
transmitting an output value defined in the API as the response signal to the address defined in the library when the API corresponding to the instruction signal exists in the library; or
transmitting an error signal for the instruction signal as the response signal to the address defined in the library when the API corresponding to the instruction signal does not exist in the library.

4. The method of supporting data collection of claim 1, wherein
the determining the response signal for the instruction signal according to presence or absence of the API corresponding to the instruction signal comprises:
parsing the instruction signal to generate an instruction; and
executing the generated instruction to determine whether the API corresponding to the instruction signal exists in the library.

5. The method of supporting data collection of claim 1, wherein
the instruction signal comprises at least one tag object designating a tag to be collected, and
each of the at least one tag object comprises a trigger object in which a condition for executing the tag object is set and a variable object designating data to be collected.

6. The method of supporting data collection of claim 5, wherein
the instruction signal is generated such that each of the at least one tag object is selectively collected based on a user interaction input corresponding to a pre-designated graphic object, and
the pre-designated graphic object comprises a first graphic object indicating a collection command corresponding to a first tag object, a first-1 graphic object indicating an execution command for a trigger condition associated with the first tag object, and a first-2 graphic object indicating a collection command for a variable associated with the first tag object.

7. The method of supporting data collection of claim 6, wherein
determining the response signal for the instruction signal according to presence or absence of the API corresponding to the instruction signal comprises:
determining whether a first tag object determined to collect a tag based on the instruction signal exists among the at least one tag object;
determining whether to collect a first trigger object included in the first tag object based on the instruction signal when the first tag object exists; and
determining whether to collect each first variable object included in the first tag object based on the instruction signal when the first tag object exists.

8. The method of supporting data collection of claim 5, wherein
the at least one tag object comprises at least one of a basic tag object using a pre-defined tag object and a user-created tag object.

9. A method of supporting data collection for a server including at least one processor, comprising:
receiving a report signal for readiness to receive instructions from a user terminal;
transmitting an instruction signal defined in a first programming language in response to the report signal; and
receiving a response signal for the instruction signal from the user terminal.

10. The method of supporting data collection of claim 9, wherein
receiving the response signal for the instruction signal from the user terminal comprises:
receiving an output value defined in an application programming interface (API) as the response signal when the API corresponding to the instruction signal exists in a library of the user terminal; or
receiving an error signal in response to the instruction signal when the API corresponding to the instruction signal does not exist in the library.

11. The method of supporting data collection of claim 10, wherein
the API corresponding to the instruction signal is defined in a second programming language corresponding to an operating system of the user terminal.

12. The method of supporting data collection of claim 10, wherein
the instruction signal is generated as an instruction for confirming whether the API corresponding to the instruction signal defined in the first programming language exists in the library when parsed by the user terminal.

13. The method of supporting data collection of claim 9, wherein
the instruction signal comprises at least one tag object designating a tag to be collected, and
each of the at least one tag object comprises a trigger object in which a condition for executing the tag object is set and a variable object designating data to be collected.

14. The method of supporting data collection of claim 13, wherein
the instruction signal is generated such that each of the at least one tag object is selectively collected based on a user interaction input corresponding to a pre-designated graphic object, and
the pre-designated graphic object comprises a first graphic object indicating a collection command corresponding to a first tag object, a first-1 graphic object indicating an execution command for a trigger condition associated with the first tag object, and a first-2 graphic object indicating a collection command for a variable associated with the first tag.

15. The method of supporting data collection of claim 14, wherein
the transmitting the instruction signal defined in the first programming language in response to the report signal comprises:
determining whether a first tag object determined to collect a tag based on the user interaction input exists among the at least one tag object;
determining whether to collect a first trigger object included in the first tag object based on the user interaction input when the first tag object exists; and
determining whether to collect each first variable object included in the first tag object based on the user interaction input when the first tag object exists.

16. The method of supporting data collection of claim 15, wherein
the at least one tag object comprises at least one of a basic tag object using a pre-defined tag object and a user-created tag object.
